(19) United States
(12) Patent Application Publication
(10) Pub. No.: US 2018/0172823 A1
(43) Pub. Date: Jun. 21, 2018

(54) SYSTEMS AND METHODS FOR REMOTE SENSING OF THE EARTH FROM SPACE

(71) Applicants: Urthecast Corp, Vancouver (CA); King Abdulaziz City of Science and Technology, Riyadh (SA)

(72) Inventor: George Tyc, Tsawwassen (CA)

(21) Appl. No.: 15/737,016

(22) PCT Filed: Jun. 15, 2016
(86) PCT No.: PCT/US2016/037675

§ 371 Date: Dec. 15, 2017

Related U.S. Application Data
(60) Provisional application No. 62/180,440, filed on Jun. 16, 2015.

(51) Int. Cl. G01S 13/90; G01S 13/86; G01S 19/13

(52) U.S. Cl. CPC G01S 13/90; G01S 19/13; G01S 13/867

(57) ABSTRACT

A constellation of satellites may include a plurality of satellites in each of two or more different orbits. Satellites in a given orbit may operate in pairs, flying in tandem, one satellite leading, the other trailing closely behind, to be positioned to image the same target(s) of interest with substantially the same orientation (geographical coincident) at substantially the same time (temporally coincident). The first satellite may acquire SAR data, determine a location of a target of interest, assess cloud cover, and based on an extent of cloud cover, can acquire additional SAR data or cause the second satellite to capture optical imaging data (e.g., cross-cueing). Selection of orbits can provide a relatively high revisit rate may be obtained, allowing frequent opportunities to image given locations on a planet (e.g., Earth). One or more ground stations communicate with the constellation of satellites, and inter-satellite communications may be employed.

### TECHNICAL FIELD

The present disclosure relates generally to systems and methods for remote sensing of the Earth from space, and, more particularly, to constellations of synthetic aperture radar (SAR) and optical satellites.

### BACKGROUND

### Brief Summary

A constellation of satellites may include a plurality of satellites in each of two or more different orbits. Satellites in a given orbit may operate in pairs, flying in tandem, one satellite leading, the other trailing closely behind, to be positioned to image the same target(s) of interest with substantially the same orientation (geographical coincident) at substantially the same time (temporally coincident). The first satellite may acquire SAR data, determine a location of a target of interest, assess cloud cover, and based on an extent of cloud cover, can acquire additional SAR data or cause the second satellite to capture optical imaging data.

A system for remote sensing of the Earth from space may be summarized as including a first plurality of satellites in a first orbit plane wherein the first orbit plane defines a sun-synchronous orbit; a second plurality of satellites in a second orbit plane wherein the second orbit plane defines a first mid-inclination orbit, each of the satellites of the first plurality of satellites and each of the satellites of the second plurality of satellites include a respective Earth observing sensor, and the second orbit plane is selected to provide at least a first determined number of average daily remote sensing opportunities for the system for a first location, the first location within a first determined range of latitudes on the Earth's surface, the first determined number of average daily remote sensing opportunities for the system for the first location being the sum of the average daily remote sensing opportunities for the first location for each of the satellites in the first and the second plurality of satellites; and a ground station communicatively coupled to each of the satellites in the first and the second plurality of satellites, the ground station operable to receive remote sensing data therefrom. The first orbit plane may provide a first number of average daily remote sensing opportunities for the first plurality of satellites for the first location, and the second orbit plane may be selected to provide the first determined number of average daily collective remote sensing opportunities for the system for the first location to be greater than four times the first number of average daily remote sensing opportunities for the first plurality of satellites for the first location. The second orbit plane may be selected to have an angle of inclination in the range of twenty-five degrees to fifty-five degrees. The first determined range of latitudes may be approximately ten degrees.

The system may further include a third plurality of satellites in a third orbit plane wherein the third orbit plane defines a second mid-inclination orbit, wherein each of the satellites of the third plurality of satellites include a respective Earth observing sensor, and the third orbit plane is selected to provide a second determined number of average daily remote sensing opportunities for the system for a second location, the second location within a second determined range of latitudes on the Earth's surface, the second determined number of average daily remote sensing opportunities for the system for the second location being the sum of the average daily remote sensing opportunities for the second location for each of the satellites in the first, the second, and the third plurality of satellites. The angle of inclination of the second mid-inclination orbit may be different from the angle of inclination of the first inclined orbit. The third orbit plane may be selected to have an angle of inclination in the range of twenty-five degrees to fifty-five degrees. The second determined range of latitudes may be approximately ten degrees. The first and the second plurality of satellites may each include one or more pairs of satellites respectively, the pairs of satellites spaced around the first and the second orbit plane respectively. The first and the second plurality of satellites may each include one or more pairs of satellites respectively, the pairs of satellites equispaced around the first and the second orbit plane respectively. The first and the second plurality of satellites may each include four pairs of satellites respectively, spaced apart around the first and the second orbit plane respectively, with quadrature phasing. At least one of the one or more pairs of satellites may include a first satellite and a second satellite, the Earth observing sensor of the first satellite including a synthetic aperture radar (SAR) sensor and the Earth observing sensor of the second satellite including an optical sensor, and wherein the first and the second satellites of the pair move in formation in the same orbit plane as one another. The second satellite may trail the first satellite by a time selected to cause data collected by the SAR sensor and the Earth-observing optical sensor of an area of interest on the Earth to be substantially temporally coincident. The second satellite may be communicatively coupled to the first satellite via a communications link to receive data therefrom. The communications link may include an inter-satellite link between the first and the second satellites. The second satellite may be operable to acquire remotely sensed data by the optical sensor in response to receiving data from the first satellite via the communications link.

The first satellite may further include a cloud camera and a first on-board processor communicatively coupled to the SAR sensor and the cloud camera to receive data therefrom, and the second satellite may further include a second on-board processor communicatively coupled to the optical sensor to receive data therefrom, the system operable to: acquire initial SAR data by the SAR sensor on the first satellite; process the SAR data, by the first on-board processor, to generate a SAR image; identify, by the first on-board processor, at least one target of interest in the SAR image; determine the location of the at least one target of interest; determine a cloud mask by the cloud camera; determine a degree of cloud cover over the at least one target of interest from the cloud mask by the first on-board processor; selectively operate the SAR sensor to acquire SAR imagery if the degree of cloud cover over the at least one target of interest exceeds a determined threshold; and cause an activation of the optical sensor on the second satellite to acquire optical imagery of the at least one target of interest if the degree of cloud cover over the at least one target of interest is at or below the determined threshold.

A method of remotely sensing the Earth from space may be summarized as including communicating with a first plurality of satellites in a first orbit plane wherein the first orbit plane defines a sun-synchronous orbit; and communicating with a second plurality of satellites in a second orbit plane wherein the second orbit plane defines a first mid-inclination orbit, each of the satellites of the first plurality of satellites and each of the satellites of the second plurality of satellites include a respective Earth observing sensor, and the second orbit plane is selected to provide a first determined number of average daily remote sensing opportunities for the first and the second plurality of satellites collectively for a first location, the first location within a first determined range of latitudes on the Earth's surface. Communicating with a first plurality of satellites in a first orbit plane may include communicating with a first plurality of satellites in a first orbit plane providing a first number of average daily sensing opportunities for the first plurality of satellites for the first location, and communicating with a second plurality of satellites in a second orbit plane may include communicating with a second plurality of satellites in a second orbit plane selected to provide the first determined number of average daily remote sensing opportunities for the first and the second plurality of satellites collectively for the first location to be greater than four times the first number of average daily remote sensing opportunities for the first plurality of satellites for the first location. Communicating with a second plurality of satellites in a second orbit plane may include communicating with a second plurality of satellites in a second orbit plane selected to have an angle of inclination in the range of twenty-five degrees to fifty-five degrees. The first determined range of latitudes may be approximately ten degrees.

The method may further include communicating with a third plurality of satellites in a third orbit plane wherein the third orbit plane defines a second inclined orbit, each of the satellites of the third plurality of satellites include a respective Earth observing sensor, and the third orbit plane is selected to cause a second determined number of average daily sensing opportunities for the first, the second, and the third plurality of satellites collectively for a second location, the second location within a second determined range of latitudes on the Earth's surface. The angle of inclination of the second mid-inclination orbit may be different from the angle of inclination of the first inclined orbit. The third orbit plane may be selected to have an angle of inclination in the range of twenty-five degrees to fifty-five degrees. The second determined range of latitudes may be approximately ten degrees. The first and the second plurality of satellites may each include one or more pairs of satellites respectively, the pairs of satellites spaced around the first and the second orbit plane respectively. The first and the second plurality of satellites may each include one or more pairs of satellites respectively, the pairs of satellites equispaced around the first and the second orbit plane respectively. The first and the second plurality of satellites may each include four pairs of satellites respectively, spaced apart around the first and the second orbit plane respectively, with quadrature phasing. At least one of the one or more pairs of satellites may include a first satellite and a second satellite, the Earth observing sensor of the first satellite including a synthetic aperture radar (SAR) sensor and the Earth observing sensor of the second satellite including an optical sensor, and wherein the first and the second satellites of the pair move in formation in the same orbit plane as one another. The second satellite may trail the first satellite by a time selected to cause data collected by the SAR sensor and the Earth-observing optical sensor of an area of interest on the Earth to be substantially temporally coincident. The second satellite may be communicatively coupled to the first satellite via a communications link to receive data therefrom. The communications link may include an inter-satellite link between the first and the second satellites. The second satellite may be operable to acquire remotely sensed data by the optical sensor in response to receiving data from the first satellite via the communications link.

The first satellite may further include a cloud camera and a first on-board processor communicatively coupled to the SAR sensor and the cloud camera to receive data therefrom, and the second satellite may further include a second on-board processor communicatively coupled to the optical sensor to receive data therefrom, the method further including acquiring initial SAR data by the SAR sensor on the first satellite; processing the SAR data, by the first on-board processor, to generate a SAR image; identifying, by the first on-board processor, at least one target of interest in the SAR image; determining the location of the at least one target of interest; determining a cloud mask by the cloud camera; determining a degree of cloud cover over the at least one target of interest from the cloud mask by the first on-board processor; selectively operating the SAR sensor to acquire SAR imagery if the degree of cloud cover over the at least one target of interest exceeds a determined threshold; and causing an activation of the optical sensor on the second satellite to acquire optical imagery of the at least one target of interest if the degree of cloud cover over the at least one target of interest is at or below the determined threshold.

A system for remote sensing of the Earth from space may be summarized as including at least one satellite pair, each of the at least satellite pair including: a first satellite including a synthetic aperture radar (SAR) sensor; a cloud camera; and a first on-board processor communicatively coupled to the SAR sensor and the cloud camera to receive data therefrom; and a second satellite including at least one optical sensor and a second on-board processor communicatively coupled to the at least one optical sensor to receive data therefrom, wherein the second satellite is communicatively coupled to the first satellite via an inter-satellite link to receive data therefrom, wherein the first and the second satellite move in formation in the same orbit plane as one another. The at least one satellite pair may include a first plurality of satellite pairs, the first plurality of satellite pairs in the same orbit plane as one another. The first plurality of satellite pairs may include four satellite pairs spaced apart around the orbit with quadrature phasing. The at least one satellite pair may include a second plurality of satellite pairs, the second plurality of satellite pairs moving in substantially the same orbit as one another, wherein the first plurality of satellite pairs move in a first orbit, and the second plurality of satellite pairs move in a second orbit, the angle of inclination of the second orbit being different from the angle of inclination of the first orbit. The second plurality of satellite pairs may include four satellite pairs substantially equally spaced around the second orbit. The first plurality of satellite pairs may be in a sun-synchronous orbit (SSO), and the second plurality of satellite pairs may be in a mid-inclination orbit (MIO).

The at least one satellite pair may further include a third plurality of satellite pairs, the third plurality of satellite pairs moving in substantially the same orbit as one another, wherein the third plurality of satellite pairs move in a third orbit, the angle of inclination of the third orbit being different from the angle of inclination of the first and the second orbits. The third plurality of satellites may be in a MIO. The first and the second satellites may move in substantially the same orbit as one another, the second satellite trailing the first satellite by a time selected to cause data collected by the first and the second satellites of an area of interest on the Earth to be substantially temporally coincident.

A method of operating the system may be summarized as including acquiring initial SAR data by the SAR sensor on the first satellite; processing the SAR data, by the first on-board processor, to generate a SAR image; identifying, by the first on-board processor, at least one target of interest in the SAR image; determining the location of the at least one target of interest; determining a cloud mask by the cloud camera; determining a degree of cloud cover over the at least one target of interest from the cloud mask by the first on-board processor; selectively operating the SAR sensor to acquire SAR imagery if the degree of cloud cover over the at least one target of interest exceeds a determined threshold; and causing an activation of the optical sensor on the second satellite to acquire optical imagery of the at least one target of interest if the degree of cloud cover over the at least one target of interest is at or below the determined threshold. Selectively operating the SAR sensor to acquire SAR imagery may include operating the SAR sensor at two frequency bands. Acquiring the initial SAR data may include acquiring the initial SAR data in a wide-swath mode, and wherein selectively operating the SAR sensor to acquire SAR imagery may include operating the SAR sensor in a fine-resolution mode. Identifying, by the first on-board processor, at least one target of interest in the SAR image may include using AIS data received from at least one of an on-board AIS sensor or a ground-based AIS sensor. Causing an activation of the optical sensor on the second satellite may include sending a signal from the first satellite to the second satellite via the inter-satellite link. Activating the optical sensor on the second satellite to acquire optical imagery may include activating the optical sensor on the second satellite to acquire video data.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings.

FIG. 1 is a block diagram of a remote sensing system, according to at least a first illustrated embodiment.

FIG. 2 is a block diagram of a remote sensing system, according to at least a second illustrated embodiment.

FIG. 3 is a schematic diagram illustrating satellites of FIG. 1 in a Sun-Synchronous Orbit (SSO) and an inclined orbit about the Earth.

FIG. 4A is a schematic diagram illustrating the field of regard for a synthetic aperture radar (SAR) satellite.

FIG. 4B is a schematic diagram illustrating the field of regard for an optical satellite.

FIG. 5A is a schematic diagram illustrating a SAR satellite and an optical satellite operable to collect remote sensing data in tandem.

FIG. 5B is a schematic diagram illustrating the field of regard for a SAR sensor and a cloud camera aboard a SAR satellite.

FIG. 6 is a series of graphs illustrating the number of daily imaging opportunities by latitude for the remote sensing system of FIG. 2.

FIG. 7 is a block diagram illustrating maritime surveillance using the remote sensing system of FIG. 1.

FIG. 8 is flow diagram of a method of operating a pair of satellites which orbit in a tandem configuration in an orbital plane, according to at least one illustrated embodiment.

### DETAILED DESCRIPTION

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

The Abstract of the Disclosure provided herein is for convenience only and does not interpret the scope or meaning of the embodiments.

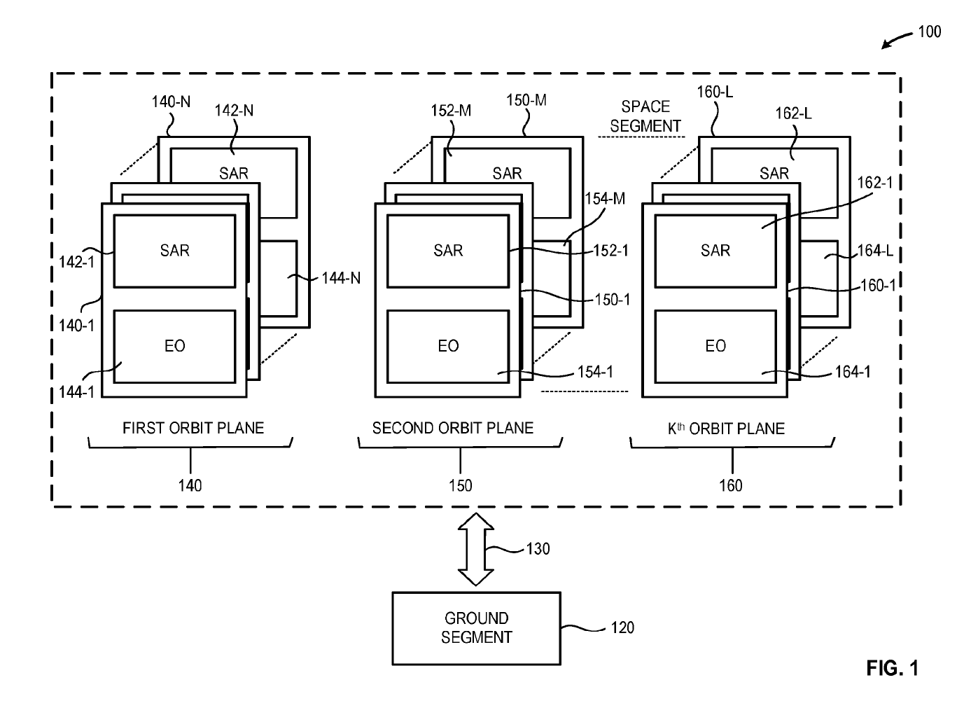

FIG. 1 is a block diagram of remote sensing system 100, according to at least a first illustrated embodiment. Remote sensing system 100 comprises space segment 110 and ground segment 120. Space segment 110 is communicatively coupled to ground segment 120 via interface 130. Interface 130 comprises one or more uplink channels and one or more downlink channels.

Space segment 110 is a constellation of one or more satellites in each of one or more orbit planes. FIG. 1 shows a set of satellites 140 in a first orbit plane in the constellation, a second set of satellites 150 in a second orbit plane in the constellation, and a set of satellites 160 in a Kth orbit plane in the constellation. Set of satellites 140 comprises one or more pairs of synthetic aperture radar (SAR) and optical satellites such as 140-1 . . . 140-N. In some implementations, a satellite may carry both SAR and optical sensors, for example a satellite that carries an L-band SAR and optical sensors. A SAR satellite is a satellite carrying at least a SAR sensor or that is dedicated to acquiring SAR data. An optical satellite is a satellite carrying one or more optical sensors or one that is dedicated to acquiring optical imagery. Each pair of satellites 140-1 through 140-N comprises a SAR satellite 142-1 through 142-N and an optical satellite 144-1 through 144-N.

Similarly, set of satellites 150 comprises one or more pairs of synthetic aperture radar (SAR) and optical satellites such as 150-1 . . . 150-M. Each pair of satellites 150-1 through 150-M comprises a SAR satellite 152-1 through 152-M and an optical satellite 154-1 through 154-M.

Similarly, set of satellites 160 comprises one or more pairs of synthetic aperture radar (SAR) and optical satellites such as 160-1, 150-2, . . . 150-L. Each pair of satellites 150-1 through 150-L comprises a SAR satellite 152-1 through 152-L and an optical satellite 154-1 through 154-L. In one embodiment, each pair of satellites flies in a tandem configuration (one satellite leading, the other satellite trailing) and closely spaced around the orbit (for example, with a separation in time of approximately 60 seconds). In this configuration, each pair of satellites can image the same target of interest with substantially the same geometry and at substantially the same time.

Each SAR satellite 142-1 through 142-N, 152-1 through 152-M, and 162-1 through 162-L comprises a SAR sensor and a cloud camera. The SAR sensor and the cloud camera are not shown in FIG. 1. Each optical satellite 144-1 through 144-N, 154-1 through 154-M, and 164-1 through 164-L comprises a push broom sensor operable in panchromatic and multi-spectral modes. Each optical satellite 144-1 through 144-N, 154-1 through 154-M, and 164-1 through 164-L further comprises a video sensor.

Each of the SAR sensors can be a single band or a multi-band sensor. For example, at least one of the SAR sensors can be a dual-band SAR. An example of a dual-band SAR is a SAR operating at X-band and L-band.

In an example constellation, satellites 140 are in a Sun-Synchronous Orbit (SSO). In a SSO, the angle of the orbit plane relative to the Sun remains fixed relative to the mean Sun position.

Satellites 150 and 160 can be in orbit planes that are inclined relative to the Equator. The inclination of the orbit planes for satellites 150 and 160 can lie between 0 degrees and 90 degrees. The orbit planes can include an equatorial orbit plane (with an inclination angle of 0 degrees) and a polar orbit plane (with an inclination angle of 90 degrees). In an example constellation, satellites 150 and 160 are in Mid-Inclination Orbit (MIO) orbit planes that are at inclinations of 45 degrees and 35 degrees respectively relative to the Equator.

In an example constellation, the pairs of satellites can be arranged with quadrature phasing, i.e., four pairs of satellites substantially equally spaced around the orbit.

Placing satellites (such as satellites in sets of satellites 140, 150, and 160) in orbit includes communicating with the satellites. Communication can be via uplink and/or downlink. Communication can be direct, for example between a ground station and one or more of the satellites. Communication can be via a radio link (e.g., RF or microwave) using an antenna at the ground station, and an antenna on the satellite. Communication can indirect, for example via one or more intersatellite links and/or via one or more ground networks.

Operating satellites includes communicating with the satellites via uplink and/or downlink, directly and/or indirectly. Acquiring data from satellites also includes communicating with the satellites via uplink and/or downlink, directly and/or indirectly.

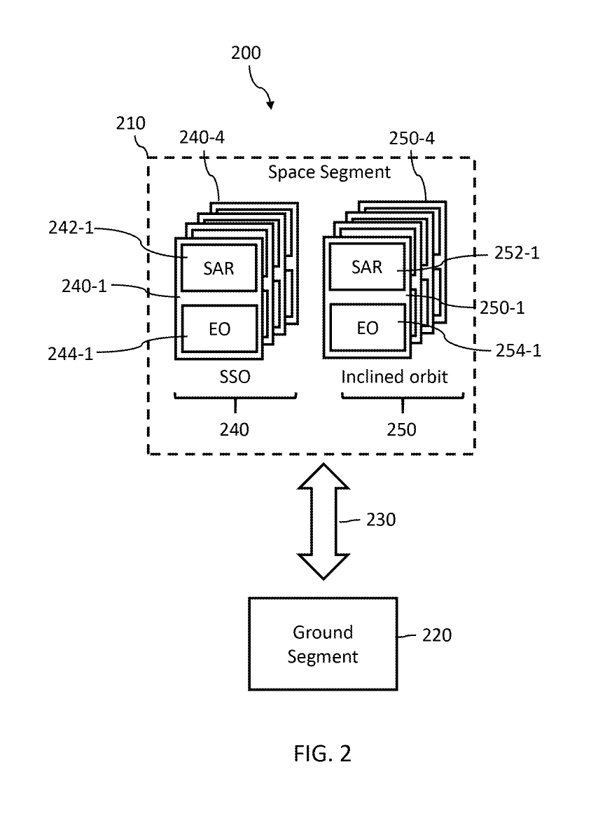

FIG. 2 is a block diagram of remote sensing system 200, according to at least a second illustrated embodiment. Remote sensing system 200 comprises space segment 210 and ground segment 220. Space segment 210 is communicatively coupled to ground segment 220 via interface 230. Interface 230 comprises one or more uplink channels and one or more downlink channels and associated radios, transceivers, transmitters, receivers and antennas.

Space segment 210 is a constellation of sixteen satellites, eight satellites 240 in a sun-synchronous orbit plane and eight satellites 250 in an inclined orbit plane (for example, a mid-inclination orbit plane). Set of satellites 240 comprises four pairs of SAR and optical satellites 242-1 through 242-4, and 244-1 through 244-4. Set of satellites 250 comprises four pairs of SAR and optical satellites 252-1 through 252-4, and 254-1 through 254-4.

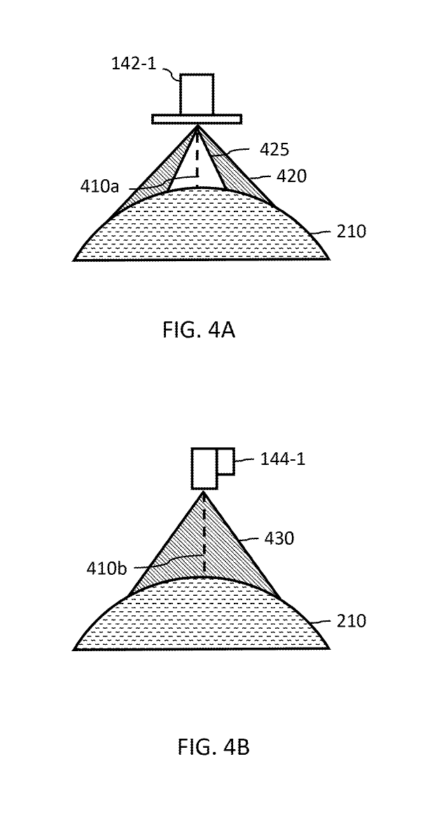

Pairs of SAR and optical satellites can be approximately equally spaced around an orbit. Within each pair, the SAR and optical satellites can operate in tandem. Each pair of satellites comprise an inter-satellite link allowing the pair to operate autonomously. The inter-satellite link can be a radio frequency (RF) link or an optical link. In an example remote sensing system, the inter-satellite link comprises an S-band link. Autonomous operation allows identification of targets of interest by the SAR satellite and cross-cueing of the optical satellite to obtain imagery and/or video data of the targets. Operation of the satellites including cross-cueing is described in more detail below, in reference to FIGS. 4A and 4B.

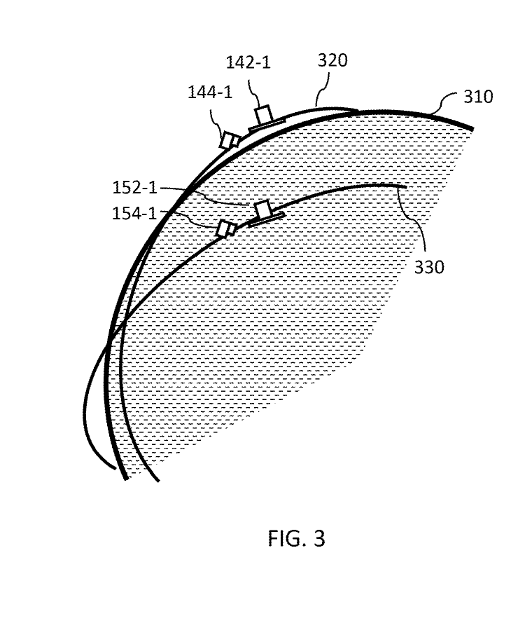

FIG. 3 is a schematic diagram illustrating the satellites of FIG. 1 in sun-synchronous orbit (SSO) 320 and inclined orbit 330 about the Earth 310. SAR satellite 142-1 and optical satellite 144-1 are in sun-synchronous orbit 320. Other SAR and optical satellites in SSO 320 are not shown in FIG. 3. SAR satellite 152-1 and optical satellite 154-1 are in inclined orbit 330. Other SAR and optical satellites in inclined orbit 330 are not shown in FIG. 3.

Sun-synchronous orbit (SSO) 320 is a geocentric orbit with orbit altitude and inclination selected to cause a satellite to appear to orbit in the same position, from the perspective of the Sun, during its orbit around the Earth. As a consequence, the surface illumination angle will be approximately the same every time that the satellite is overhead a given position on the Earth's surface. In one example, a satellite in sun-synchronous orbit can have an orbit altitude of approximately 450 km, an inclination of approximately 97.2° and a crossing time at the equator of 10:30 am.

A benefit of SSO 320 is that it provides approximately consistent illumination geometry for satellites of a remote sensing system that, for example, image the Earth's surface at visible or infrared wavelengths.

The angle of inclination of an orbit or an orbit plane is defined as the angle between the orbit plane and the Earth's equatorial plane. The Earth's equatorial plane is the plane perpendicular to the axis of rotation of the Earth. Inclined orbit 330 is a geocentric orbit having an angle of inclination of between 0° and 90°. An example of inclined orbit 330 is a mid-inclination orbit (MIO). A MIO is a geocentric orbit having an angle of inclination of between approximately 25° and 60°. In one example, a satellite in MIO can have an orbit altitude of approximately 450 km and an angle of inclination of approximately 45°.

In one implementation, one or more satellites are in an SSO orbit, and one or more satellites are in a MIO. For example, SAR satellite 142-1 and optical satellite 144-1 are in sun-synchronous orbit 320, and SAR satellite 152-1 and optical satellite 154-1 are in inclined orbit 330 where inclined orbit 300 is a MIO.

A benefit of a MIO is high revisit opportunities especially at mid-latitudes. A MIO also provides the opportunity to image the Earth at different times of the day, and to provide improved sampling of time-varying conditions such as cloud cover.

A benefit of a remote sensing system (such as remote sensing system 100 of FIG. 1) comprising two sets of satellites, one set of satellites in SSO and another set of satellites in MIO, is that it can provide very high revisit capabilities in the mid-latitude zones (for example at 30-50 degree latitudes) where it can provide imaging opportunities multiple times per day (for example greater than 10 times per day). Most of the Earth's population lives at mid-latitudes which means that mid-latitudes are of high interest for high re-visit opportunities. Another benefit is that satellites in the remote sensing system described above can image the same location at approximately the same time using both SAR and optical sensors. Yet another benefit is the opportunity to perform improved multi-spectral imaging through cloud avoidance.

FIG. 4A is a schematic diagram illustrating the field of regard (FOR) between 420 and 425 for synthetic aperture radar (SAR) satellite 142-1. SAR satellite 142-1 can roll from nadir 410a to be either left-looking or right-looking. In one example, the FOR 420 to 425 is approximately 15 degrees to 39 degrees in either left or right-looking modes.

The beam can be oriented within FOR 420 to 425 by, for example, steering the satellite, electronically steering the beam, or a combination of both approaches.

FIG. 4B is a schematic diagram illustrating the field of regard 430 for optical satellite 152-1. FOR 430 includes nadir 410b. In one example, FOR 430 is approximately +39°. Optical satellite 152-1 can roll to point a camera within FOR 430.

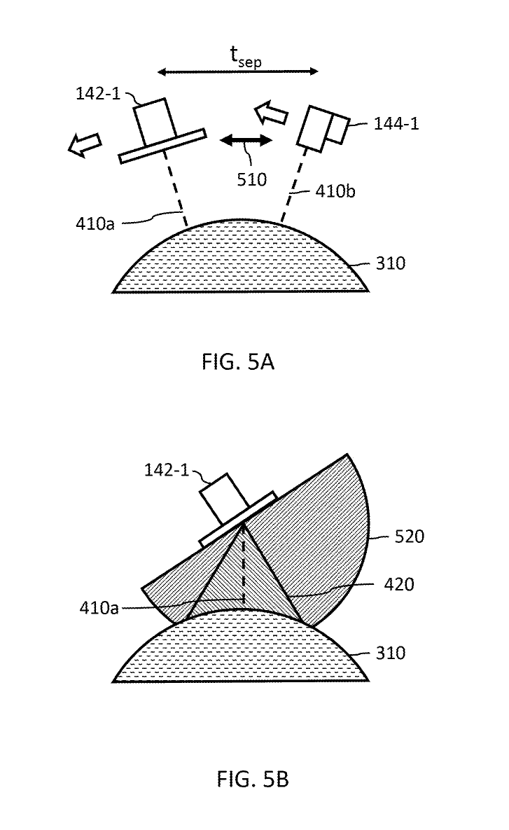

FIG. 5A is a schematic diagram illustrating a SAR satellite 142-1 and an optical satellite 144-1 operable to collect remote sensing data in tandem. SAR satellite 142-1 and optical satellite 144-1 each comprise on-board processing capability.

In one mode of cross-cueing operation of the satellites in tandem, SAR satellite 142-1 acquires raw SAR data in a wide-swath mode (e.g., ScanSAR mode). The raw SAR data is processed on-board SAR satellite 142-1 to generate SAR images and/or to detect a set of targets, such as ships.

Tasking of SAR satellite 142-1 can include specific criteria for defining a “target of interest” from targets detected in the wide-swath images. In one implementation, the criteria are based on automatic identification system (AIS) data to provide collateral information about the set of detected targets. The SAR satellite on-board processor then applies the criteria and the collateral information to determine a target of interest from the set of detected targets. The SAR satellite then determines the geolocation (e.g., longitude and latitude) of the target of interest.

SAR satellite 142-1 can also generate a cloud mask from data acquired by the cloud camera. SAR satellite 142-1 can determine whether or not a target of interest is presently obscured by clouds. If a target of interest is not presently obscured by clouds, SAR satellite 142-1 can transmit the target geolocation information to optical satellite 144-1 via inter-satellite link 510.

After receiving information about the target(s) of interest from SAR satellite 142-1, optical satellite 144-1 is able to override its current acquisition schedule, and acquire optical imagery and/or video of the target(s) of interest using sensors on-board optical satellite 144-1 such as a high-resolution push broom camera and/or high-resolution video camera.

If a target of interest is presently obscured by clouds, SAR satellite 142-1 can select a fine-resolution SAR imaging mode and acquire high-resolution SAR imagery of the otherwise obscured target of interest.

In another mode of cross-cueing operation of the satellites in tandem, SAR satellite 142-1 generates a cloud mask using the on-board cloud camera, and transmits the cloud mask to optical satellite 144-1 via inter-satellite link 510. Optical satellite 144-1 computes a preferred tasking scenario over a region of interest using its on-board processor. Typically, the tasking scenario is designed to acquire as much cloud-free imagery as possible given the constraints over regions of interest.

As shown in FIG. 5A, SAR satellite 142-1 and optical 144-1 are separated by time tₛₑₚ around the orbit. In one example, tₛₑₚ is approximately 1 minute.

As mentioned above, SAR satellite 142-1 can comprise a cloud camera, and a pair of satellites operating in tandem (such as SAR satellite 142-1 and optical satellite 144-1 of FIG. 4A) can be operable to reduce or eliminate the presence of cloud cover in optical images of targets of interest.

FIG. 5B is a schematic diagram illustrating field of regard (FOR) 420 for a SAR sensor and FOR 520 for a cloud camera aboard SAR satellite 142-1. Nadir is shown by dashed line 410a. SAR satellite 142-1 is operating in tandem with an optical satellite (such as optical satellite 144-1 of FIG. 4A) in the same orbit plane, a short time behind SAR satellite 142-1 and having approximately the same outer limits to the FOR as SAR satellite 142-1. The cloud camera FOR 520 is substantially larger than the optical satellite FOR 420 which allows the SAR satellite to be at any desired roll angle within its FOR, and the cloud camera will also provide coverage over the entire optical satellite FOR.

SAR satellite 142-1 uses the cloud camera to generate a real-time cloud mask. The cloud mask can be transferred to the optical satellite via the inter-satellite link 510. Optical satellite 144-1 then determines on-board a preferred path and/or set of targets of interest to avoid cloud cover.

The method described above can, for example, be conducted in a continuous imaging mode, where the cloud camera is continuously “streaming” cloud mask data of the field of regard (FOR) to the optical satellite. In this mode, the optical satellite has continuous cloud mask data from its current location to the location of the SAR satellite. In an example constellation, the SAR satellite can lead the optical satellite by approximately 60 seconds. The optical satellite can compute an imaging path that increases the likelihood of acquiring cloud-free imagery, the path being periodically updated.

In another example, the cloud data mask data is acquired by the SAR satellite in blocks, and each block is sent to the optical satellite via the inter-satellite link. The optical satellite then computes an imaging path, that increases the likelihood of acquiring cloud-free imagery, for an area on the ground corresponding to each block of cloud mask data.

A benefit of tandem operation as described above is that the viewing geometry is approximately the same for the pair of satellites, and the separation in time between acquisition of SAR data and optical is sufficiently short that the cloud cover and other time-varying elements (such as motion of the targets of interest) will be substantially unchanged. Tandem operation can result in improved image products when SAR data and optical data, acquired by approximately coincident SAR and optical satellites respectively, are fused. Data fusion can generate image products having greater information content about the scene being imaged.

In FIGS. 4A, 5A and 5B, SAR satellite 142-1 is used as an example for the purposes of illustration. Other SAR satellites in other orbit planes such as satellites 140, 150, and 160 (for example, SAR satellites 142-2 through 142-N, 152-1 through 152-M, and 162-1 through 162-L) operate in substantially the same way.

Similarly, in FIGS. 3B and 4A, optical satellite 144-1 is used as an example for the purposes of illustration. Other optical satellites in constellations 140 and 150 (for example, optical satellites 144-2 through 144-N, 154-1 through 154-M, and 164-1 through 164-L) operate in substantially the same way.

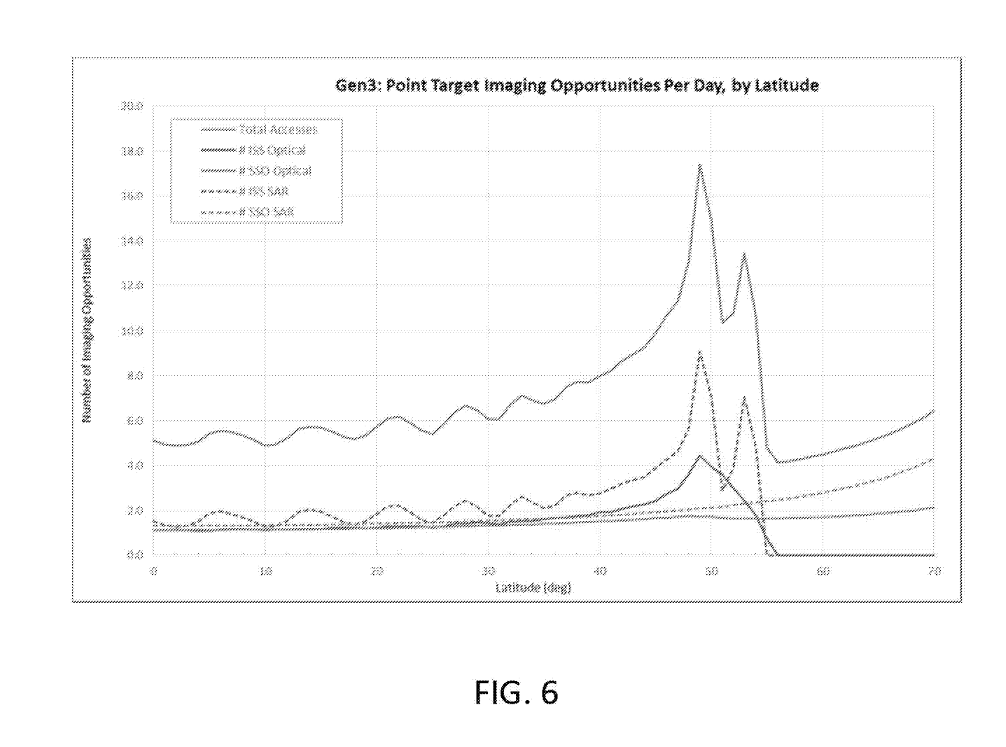

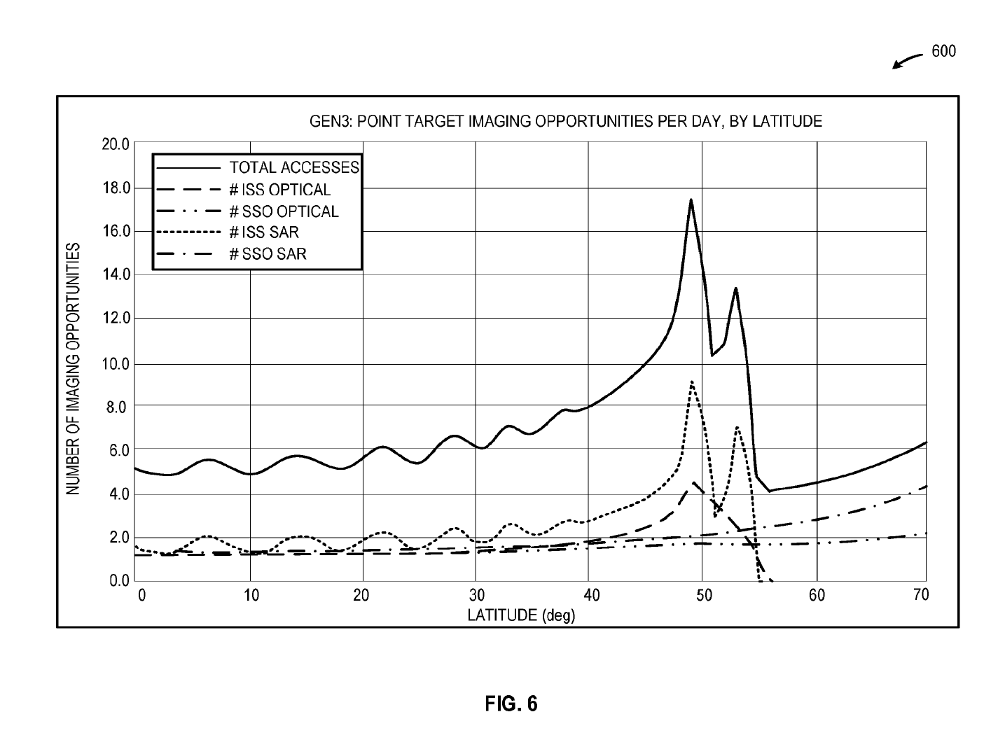

FIG. 6 is a series of graphs illustrating the number of daily imaging opportunities by latitude for the remote sensing system of FIG. 2. The number of imaging opportunities depends on the type of orbit, its altitude and angle of inclination.

Typically, a sun-synchronous orbit for an optical satellite provides between approximately 1 and 2 imaging opportunities a day. The same orbit for a SAR satellite provides between approximately 1 and 4 imaging opportunities a day.

A mid-inclination orbit can provide more daily imaging opportunities for some latitudes especially at mid-latitudes, depending on the altitude of the satellite.

As FIG. 6 shows, a remote sensing system, such as remote sensing system 200 of FIG. 2, can be operable to provide a large increase in revisit opportunities at locations between approximately 35 degrees latitude to near 50 degrees latitude with up to approximately 16 imaging opportunities per day in the example shown, and more than 4 imaging opportunities at all latitudes.

Satellites in a second mid-inclination orbit can be included in the constellation. In one example, as described above, the first MIO can be selected to have an angle of inclination of 45 degrees, and the second MIO can be selected to have an angle of inclination of 35 degrees. Adding a second MIO can extend the range of latitudes over which there is an increase in revisit opportunities. In the example of a 45 degree MIO and a 35 degree MIO, an increase in revisit opportunities relative a single SSO can be achieved over latitudes from approximately 30 degrees to approximately 50 degrees.

The altitude of each orbit can be selected to provide the desired ground coverage.

A benefit of remote sensing system 200 of FIG. 2, comprising one set of SAR and optical satellite pairs in SSO and a second set of SAR and optical satellite pairs in MIO, is the high number of imaging opportunities, or equivalently short re-visit time. Targets of interest can be viewed several times a day. Opportunities for cloud free imagery and/or video are increased.

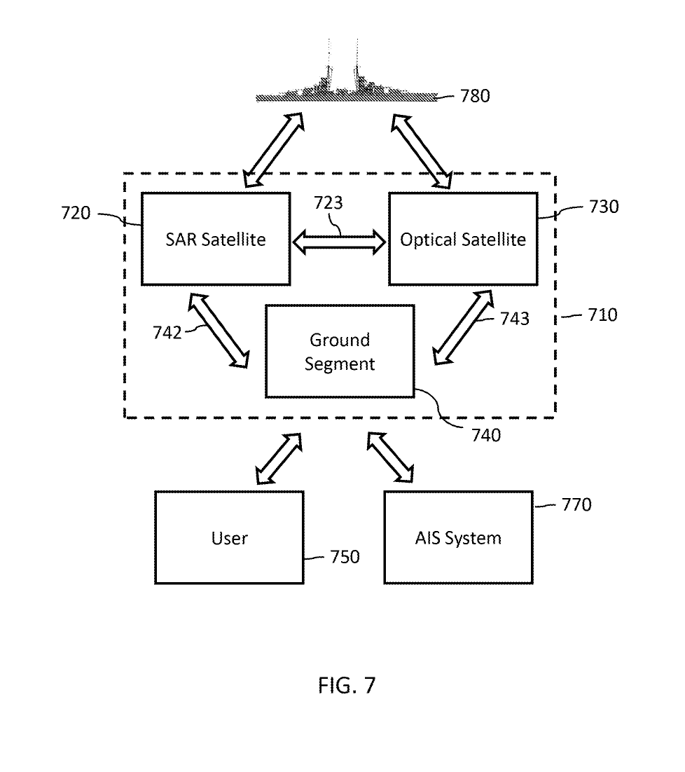

FIG. 7 is a block diagram illustrating maritime surveillance using the remote sensing system of FIG. 1. In the example scenario illustrated in FIG. 7, user 750 requests remote sensing system 710 to acquire cloud-free optical imagery and/or video of one or more targets of interest 780.

Remote sensing system 710 comprises at least one SAR satellite 720 and at least one optical satellite 730. Satellites 720 and 730 can operate in tandem as described above. Satellites 720 and 730 can process data on-board and can communicate with each other via an inter-satellite link 723. Remote sensing system 710 further comprises a ground segment 740 communicatively coupled to satellites 720 and 730 via interfaces 742 and 743, respectively. Interfaces 742 and 743 comprise uplinks and downlinks.

In operation, SAR satellite 720 acquires ScanSAR data over a 100 km swath, the data being processed on-board the satellite to detect and locate one or more targets of interest 780. Typically, automatic identification system (AIS) 770 supplies remote sensing system 710 with information about the location and identity of ships. The information can be uplinked to SAR satellite 720 from the ground to assist in identification of specific targets of interest 780. Alternatively, an AIS sensor can be included on-board the SAR satellite, and the AIS information used directly by the SAR satellite.

Information about targets of interest 780 including latitude and longitude coordinates of their positions is communicated to optical satellite 730 via ISL 723. In response, optical satellite 730 can slew and set up for imaging using its optical sensors such as a push broom sensor and video camera. Typically, optical satellite 730 can acquire high-resolution imagery and video, spectral information and 3D reconstruction of one or more targets of interest 780.

Maritime surveillance, as illustrated in FIG. 7, is only one example of the application of remote sensing system 100 of FIG. 1. There is a wide range of possible applications of the technology including, but not limited to, agriculture, forestry monitoring, surveillance and the like, data analytics using Earth observation data, and consumer/social media-based applications.

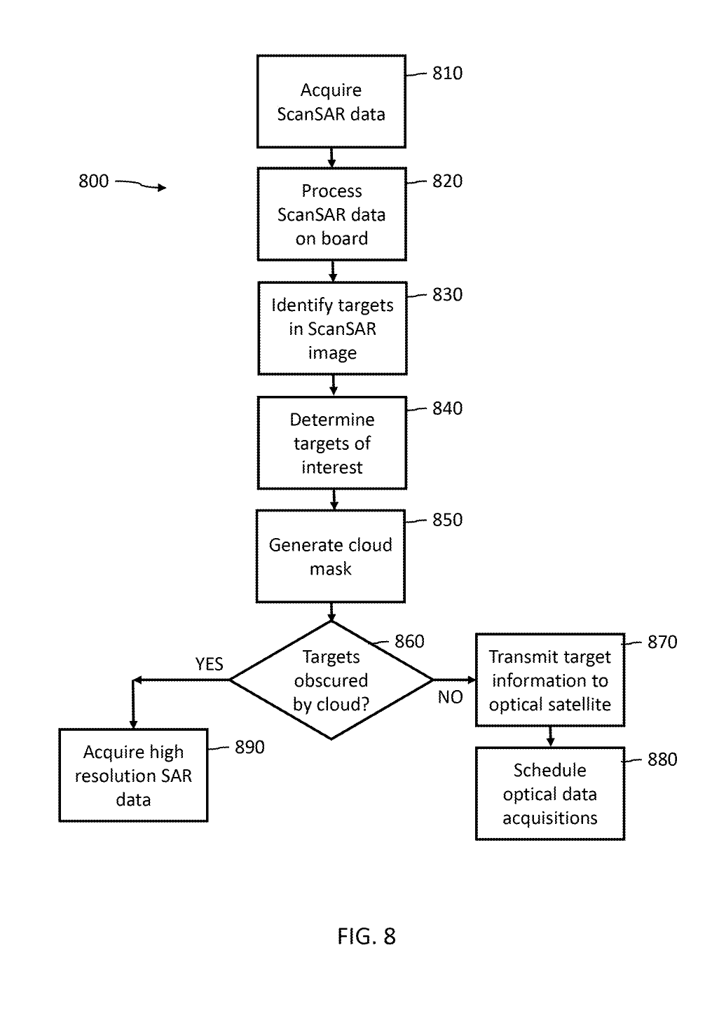

FIG. 8 is a flow chart illustrating a method of tandem operation. At 810, SAR satellite 142-1 acquires ScanSAR data for a wide swath over a region of interest. At 820, SAR satellite 142-1 processes the ScanSAR data to form a ScanSAR image, with sufficient resolving power to detect targets. At 830, SAR satellite 142-1 identifies targets in the ScanSAR image. At 840, SAR satellite 142-1 determines, using, for example, geolocation and AIS data, and uplinked criteria, whether one or more of the targets are “targets of interest.”

At 850, SAR satellite 142-1 generates a cloud mask for the region of interest. At 860, SAR satellite 142- determines whether the targets of interest are presently obscured by cloud. If the targets are not presently obscured by cloud, then, at 870, SAR satellite 142-1 transmits target information to optical satellite 144-1 via inter-satellite link 510. At 880, optical satellite 144-1 computes a set of commands for acquiring optical image and video data of the targets of interest.

If, at 860, SAR satellite 142- determines that the targets of interest are presently obscured by cloud, then, at 890, SAR satellite 142-1 acquires high-resolution SAR image of the region of interest.

In summary, the technology described above comprises one or more of the following elements:
A constellation of SAR satellites and optical satellites
On-board processing on one or both of the SAR and the optical satellites
Inter-satellite link between autonomous or semi-autonomous pairs of satellites, operable in tandem
Cross-cueing between each satellite in a pair
Cloud camera on the forward satellite, for example on the SAR satellite
Use of AIS to provide information on potential targets of interest for maritime surveillance applications, and to provide collateral intelligence regarding the position and identity of targets detected by the satellites
Use of the optical satellite to acquire high-resolution push broom imagery and/or high-resolution video data of target of interest or areas of interest
3D reconstruction of targets of interest from high-resolution video data
Use of spectral information (push-broom sensor) to provide additional information about targets of interest
Use of ScanSAR on the forward (SAR) satellite to detect targets of interest (such as ships) over a wide swath
Use of a fine resolution SAR mode to generate high-resolution radar images of targets of interest
Improved cloud avoidance tasking of optical satellite via cross-cueing, for example by having the SAR satellite send cloud mask data for the area forward of the optical satellite and/or by having the SAR satellite send information about targets of interest that are not presently obscured by clouds
Correct geometry of the cloud camera situated on the forward (SAR) satellite for establishing an accurate cloud mask. For example, the viewing geometry of the cloud camera is substantially the same as the viewing geometry of the pushbroom camera on the optical satellite. This is significant as the clouds have complex 3-D structures, and, if the viewing geometry of the cloud camera is different than the optical satellite (for example, if the cloud camera is on the same satellite and is looking forward while the optical camera's bore sight is oriented along nadir), then this can complicate the on-board processing needed to generate an accurate cloud mask. With different viewing geometries, the 3-D cloud structures would have to be accurately determined to transform the cloud mask into the same viewing geometry used by the optical camera on the optical satellite.
Tandem operation of satellites, closely spaced in time, to provide an accurate cloud mask and substantially the same geometry and time for acquiring SAR and optical imagery
Data fusion of SAR and optical imagery acquired at substantially the same geometry and time to provide greater information content extraction from the data
Combination of SSO and inclined orbit planes to provide high re-visit opportunities (short re-visit times) in areas of high interest to potential consumers of the data
Combination of SSO and MIO orbits to provide increased daily imaging opportunities.

The above description of illustrated embodiments, including what is described in the Abstract, is not intended to be exhaustive or to limit the various embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other imaging systems, not necessarily the exemplary satellite imaging systems generally described above.

While the foregoing description refers, for the most part, to satellite platforms for SAR and optical sensors, remotely sensed imagery can be acquired using airborne sensors including, but not limited to, aircraft and drones. The technology described in this disclosure can be applied to imagery acquired from sensors on spaceborne and airborne platforms.

The various embodiments described above can be combined to provide further embodiments. U.S. Provisional Patent Application Ser. No. 62/137,934, filed Mar. 25, 2015 (Atty. Docket No. 920140.404P1); U.S. Provisional Patent Application Ser. No. 62/180,421, filed Jun. 16, 2015 and entitled “EFFICIENT PLANAR PHASED ARRAY ANTENNA ASSEMBLY” (Atty. Docket No. 920140.405P1); U.S. Provisional Patent Application Ser. No. 62/180,440, filed Jun. 16, 2015 and entitled “SYSTEMS AND METHODS FOR REMOTE SENSING OF THE EARTH FROM SPACE” (Atty. Docket No. 920140.406P1); and U.S. Provisional Patent Application Ser. No. 62/180,449, filed Jun. 16, 2015 and entitled “SYSTEMS AND METHODS FOR ENHANCING SYNTHETIC APERTURE RADAR IMAGERY” (Atty. Docket No. 920140.407P1), are each incorporated herein by reference, in their entirety. Aspects of the embodiments can be modified, if necessary, to employ systems, circuits and concepts of the various patents, applications and publications to provide yet further embodiments.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms of taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

These and other changes can be made in light of the above-detailed description. In general, in the following claims, the terms used should not be construed to limit the invention to the specific embodiments disclosed in the specification and the claims, but should be construed to include all possible embodiments along with the full scope of equivalents to which such claims are entitled. Accordingly, the invention is not limited by the disclosure.

1. A system for remote sensing of the Earth from space, the system comprising:
a first plurality of satellites in a first orbit plane wherein the first orbit plane defines a sun-synchronous orbit;
a second plurality of satellites in a second orbit plane wherein the second orbit plane defines a first mid-inclination orbit, each of the satellites of the first plurality of satellites and each of the satellites of the second plurality of satellites include a respective Earth observing sensor, and the second orbit plane is selected to provide at least a first determined number of average daily remote sensing opportunities for the system for a first location, the first location within a first determined range of latitudes on the Earth's surface, the first determined number of average daily remote sensing opportunities for the system for the first location being the sum of the average daily remote sensing opportunities for the first location for each of the satellites in the first and the second plurality of satellites; and
a ground station communicatively coupled to each of the satellites in the first and the second plurality of satellites, the ground station operable to receive remote sensing data therefrom.

2. The system of claim 1 wherein the first orbit plane provides a first number of average daily remote sensing opportunities for the first plurality of satellites for the first location, and the second orbit plane is selected to provide the first determined number of average daily collective remote sensing opportunities for the system for the first location to be greater than four times the first number of average daily remote sensing opportunities for the first plurality of satellites for the first location.

3. The system of claim 1 wherein the second orbit plane is selected to have an angle of inclination in the range of twenty-five degrees to fifty-five degrees.

4. The system of claim 1 wherein the first determined range of latitudes is approximately ten degrees.

5. The system of claim 1, further comprising:
a third plurality of satellites in a third orbit plane wherein the third orbit plane defines a second mid-inclination orbit, wherein each of the satellites of the third plurality of satellites comprise a respective Earth observing sensor, and the third orbit plane is selected to provide a second determined number of average daily remote sensing opportunities for the system for a second location, the second location within a second determined range of latitudes on the Earth's surface, the second determined number of average daily remote sensing opportunities for the system for the second location being the sum of the average daily remote sensing opportunities for the second location for each of the satellites in the first, the second, and the third plurality of satellites.

6. The system of claim 5 wherein the angle of inclination of the second mid-inclination orbit is different from the angle of inclination of the first inclined orbit.

7. The system of claim 5 wherein the third orbit plane is selected to have an angle of inclination in the range of twenty-five degrees to fifty-five degrees.

8. The system of claim 5 wherein the second determined range of latitudes is approximately ten degrees.

9. The system of claim 1 wherein the first and the second plurality of satellites each comprise one or more pairs of satellites respectively, the pairs of satellites spaced around the first and the second orbit plane respectively.

10. The system of claim 1 wherein the first and the second plurality of satellites each comprise one or more pairs of satellites respectively, the pairs of satellites equispaced around the first and the second orbit plane respectively.

11. The system of claim 10 wherein the first and the second plurality of satellites each comprise four pairs of satellites respectively, spaced apart around the first and the second orbit plane respectively, with quadrature phasing.

12. The system of claim 9 wherein at least one of the one or more pairs of satellites comprises a first satellite and a second satellite, the Earth observing sensor of the first satellite comprising a synthetic aperture radar (SAR) sensor and the Earth observing sensor of the second satellite comprising an optical sensor, and wherein the first and the second satellites of the pair move in formation in the same orbit plane as one another.

13. The system of claim 12 wherein the second satellite trails the first satellite by a time selected to cause data collected by the SAR sensor and the Earth-observing optical sensor of an area of interest on the Earth to be substantially temporally coincident.

14. The system of claim 12 wherein the second satellite is communicatively coupled to the first satellite via a communications link to receive data therefrom.

15. The system of claim 14 wherein the communications link comprises an inter-satellite link between the first and the second satellites.

16. The system of claim 14 wherein the second satellite is operable to acquire remotely sensed data by the optical sensor in response to receiving data from the first satellite via the communications link.

17. The system of claim 16 wherein the first satellite further comprises a cloud camera and a first on-board processor communicatively coupled to the SAR sensor and the cloud camera to receive data therefrom, and the second satellite further comprises a second on-board processor communicatively coupled to the optical sensor to receive data therefrom, the system operable to:
acquire initial SAR data by the SAR sensor on the first satellite;
process the SAR data, by the first on-board processor, to generate a SAR image;
identify, by the first on-board processor, at least one target of interest in the SAR image;
determine the location of the at least one target of interest;
determine a cloud mask by the cloud camera;
determine a degree of cloud cover over the at least one target of interest from the cloud mask by the first on-board processor;
selectively operate the SAR sensor to acquire SAR imagery if the degree of cloud cover over the at least one target of interest exceeds a determined threshold; and
cause an activation of the optical sensor on the second satellite to acquire optical imagery of the at least one target of interest if the degree of cloud cover over the at least one target of interest is at or below the determined threshold.

18. A method of remotely sensing the Earth from space, the method comprising:
communicating with a first plurality of satellites in a first orbit plane wherein the first orbit plane defines a sun-synchronous orbit; and
communicating with a second plurality of satellites in a second orbit plane wherein the second orbit plane defines a first mid-inclination orbit, each of the satellites of the first plurality of satellites and each of the satellites of the second plurality of satellites comprise a respective Earth observing sensor, and the second orbit plane is selected to provide a first determined number of average daily remote sensing opportunities for the first and the second plurality of satellites collectively for a first location, the first location within a first determined range of latitudes on the Earth's surface.

19. The method of claim 18 wherein communicating with a first plurality of satellites in a first orbit plane includes communicating with a first plurality of satellites in a first orbit plane providing a first number of average daily sensing opportunities for the first plurality of satellites for the first location, and communicating with a second plurality of satellites in a second orbit plane includes communicating with a second plurality of satellites in a second orbit plane selected to provide the first determined number of average daily remote sensing opportunities for the first and the second plurality of satellites collectively for the first location to be greater than four times the first number of average daily remote sensing opportunities for the first plurality of satellites for the first location.

20. The method of claim 18 wherein communicating with a second plurality of satellites in a second orbit plane includes communicating with a second plurality of satellites in a second orbit plane selected to have an angle of inclination in the range of twenty-five degrees to fifty-five degrees.

21. The method of claim 18 wherein the first determined range of latitudes is approximately ten degrees.

22.-26. (canceled)

27. The method of claim 18 wherein the first and the second plurality of satellites each comprise one or more pairs of satellites respectively, the pairs of satellites equispaced around the first and the second orbit plane respectively.

28.-33. (canceled)

34. The method of claim 18 wherein communicating with a first and a second plurality of satellites includes communicating with a first and a second plurality of satellites each comprising one or more pairs of satellites respectively, the pairs of satellites spaced around the first and the second orbit plane respectively, at least one of the one or more pairs of satellites comprising a first satellite and a second satellite, the Earth observing sensor of the first satellite comprising a synthetic aperture radar (SAR) sensor and the Earth observing sensor of the second satellite comprising an optical sensor, the first and the second satellites of the pair moving in formation in the same orbit plane as one another, the second satellite communicatively coupled to the first satellite via a communications link to receive data therefrom, the first satellite further comprising a cloud camera and a first on-board processor communicatively coupled to the SAR sensor and the cloud camera to receive data therefrom, the second satellite further comprises a second on-board processor communicatively coupled to the optical sensor to receive data therefrom, the method further comprising
acquiring initial SAR data by the SAR sensor on the first satellite;
processing the SAR data, by the first on-board processor, to generate a SAR image;
identifying, by the first on-board processor, at least one target of interest in the SAR image;
determining the location of the at least one target of interest;
determining a cloud mask by the cloud camera;
determining a degree of cloud cover over the at least one target of interest from the cloud mask by the first on-board processor;
selectively operating the SAR sensor to acquire SAR imagery if the degree of cloud cover over the at least one target of interest exceeds a determined threshold; and
causing an activation of the optical sensor on the second satellite to acquire optical imagery of the at least one target of interest if the degree of cloud cover over the at least one target of interest is at or below the determined threshold.

35. A system for remote sensing of the Earth from space, the system comprising at least one satellite pair, each of the at least satellite pair comprising:
a first satellite comprising:
a synthetic aperture radar (SAR) sensor;
a cloud camera; and
a first on-board processor communicatively coupled to the SAR sensor and the cloud camera to receive data therefrom; and
a second satellite comprising at least one optical sensor and a second on-board processor communicatively coupled to the at least one optical sensor to receive data therefrom, wherein the second satellite is communicatively coupled to the first satellite via an inter-satellite link to receive data therefrom,
wherein the first and the second satellite move in formation in the same orbit plane as one another.

36.-37. (canceled)

38. The system of claim 35 wherein the at least one satellite pair comprises a first plurality of satellite pairs, the first plurality of satellite pairs in the same orbit plane as one another, and the at least one satellite pair comprises a second plurality of satellite pairs, the second plurality of satellite pairs moving in substantially the same orbit as one another, wherein the first plurality of satellite pairs move in a first orbit, and the second plurality of satellite pairs move in a second orbit, the angle of inclination of the second orbit being different from the angle of inclination of the first orbit.

39. (canceled)

40. The system of claim 38 wherein the first plurality of satellite pairs is in a sun-synchronous orbit (SSO), and the second plurality of satellite pairs is in a mid-inclination orbit (MIO).

41.-49. (canceled)

50. The system of claim 38 wherein the first plurality of satellite pairs is in a first mid-inclination orbit (MIO) and the second plurality of satellite pairs is in a second MIO.
